(19) United States
(12) Patent Application Publication
(10) Pub. No.: US 2012/0206404 A1
(43) Pub. Date: Aug. 16, 2012

(54) TOUCH SENSING APPARATUS

(76) Inventors: Chien-Yu Chan, Hsinchu City (TW); Chein-Kuo Wang, Zhubei City (TW); Jen-Hung Tung, Hsinchu County (TW); Hung Li, Taipei City (TW); Ko-Yang Tso, Taipei City (TW)

(21) Appl. No.: 13/370,192

(22) Filed: Feb. 9, 2012

(30) Foreign Application Priority Data
Feb. 10, 2011 (TW) 100104390

(51) Int. Cl. G06F 3/044

(52) U.S. Cl. 345/174

(57) ABSTRACT

A touch sensing apparatus includes a logic control module and at least one input control module. The logic control module generates a plurality of control signals having different control timings, wherein the control signals include an input control signal. The input control module is coupled with the logic control module, wherein each input control module includes a positive input switch and a negative input switch. The input control module controls, according to the input control signal, the positive input switch and the negative input switch to be deactivated or activated to control an input mode of a first sensing voltage and a second sensing voltage, which are analog data respectively sensed through a first sensing line and a second sensing line of a conductive thin film sensor, wherein the first sensing line and the second sensing line are sensing lines of adjacent channels.

### CROSS-REFERENCE TO RELATED APPLICATIONS

This application claims the benefit of priority from Taiwanese Patent Application No. 100104390, filed on Feb. 10, 2011, which application is incorporated herein by reference.

### BACKGROUND OF THE INVENTION

1. Field of the Invention

The present invention relates generally to a liquid crystal display; particularly, the present invention relates to a mutual capacitance touch sensing apparatus capable of increasing the sensing voltage accuracy and having a good anti-noise ability.

2. Description of the Prior Art

As technology rapidly advances, conventional displays are progressively replaced by thin film transistor liquid crystal displays (TFT LCDs). TFT LCDs are widely used in TVs, flat displays, cell phones, tablet PCs, projectors, and other relevant electronic devices. For TFT LCDs having touch function, touch sensors play an important role among all other modules, and performance of the touch sensor affects the overall performance of LCD.

Generally, the conventional LCD having mutual capacitance touch sensing function includes a display panel, a conductive thin film sensor (e.g. ITO sensor), and a touch control chip, wherein the conductive thin film sensor includes a plurality of sensing lines and a plurality of driving lines, and the touch control chip includes a plurality of pins. The sensing lines are coupled with the pins, respectively. When the driving line transmits a driving pulse to couple a small voltage on the sensing line, the touch control chip will sense the coupled voltage and determine according to the magnitude of the coupled voltage whether the conductive thin film sensor is touched.

Particularly, the performance of the touch sensing apparatus depends on the sensing voltage accuracy of the conductive thin film sensor. The touch sensing apparatus includes an amplifying module, and the input mode of the amplifying module includes a differential input mode and a single-ended input mode. The advantage of the touch sensing apparatus utilizing the differential input mode includes a good ability of resisting noises, but the touch sensing apparatus cannot precisely sense the exact voltage information on the panel boundary. On the other hand, the touch sensing apparatus utilizing the single-ended input mode has the advantage of precisely sensing the voltage on the panel boundary but with a poor anti-noise ability. Hence, the amplifying module of conventional touch sensing apparatus utilizing the differential input mode or the single-ended input mode still has the disadvantages described above.

Hence, the present invention provides a touch sensing apparatus with increased sensing voltage accuracy and improved anti-noise ability.

### SUMMARY OF THE INVENTION

The present invention provides a touch sensing apparatus. In an embodiment, the touch sensing apparatus includes a logic control module and at least one input control module. The logic control module generates a plurality of control signals having different control timings, wherein the control signals include an input control signal.

It is noted that the at least one input control module is coupled with the logic control module, wherein each input control module includes a positive input switch and a negative input switch. The input control module controls, according to the input control signal, the positive input switch and the negative input switch to be deactivated or to be activated to control an input mode of a first sensing voltage and a second sensing voltage. The first sensing voltage and the second sensing voltage are analog data respectively sensed through a first sensing line and a second sensing line of a conductive thin film sensor, and the first sensing line and the second sensing line are sensing lines of adjacent channels.

In addition, the touch sensing apparatus further includes at least one decoding control module and at least one amplifying control module. The at least one decoding control module is coupled with the logic control module and the at least one input control module, wherein each decoding control module includes a first decoding unit and a second decoding unit. The first decoding unit and the second decoding unit output the first sensing voltage and the second sensing voltage according to a decoding control signal of the control signals.

The at least one amplifying module is coupled with the at least one decoding control module and the logic control module, wherein each amplifying module includes a positive input end and a negative input end. The amplifying unit determines, according to an amplifying control signal of the control signals, a difference between the first sensing voltage and the second sensing voltage respectively received by the positive input end and the negative input end and amplifies the difference to output an analog data.

When the input control module, in a first differential input mode, controls the positive input switch and the negative input switch to be deactivated or to be activated according to the input control signal, the positive input end receives the first sensing voltage outputted from the first decoding unit, and the negative input end receives the second sensing voltage outputted from the second decoding unit.

When the input control module, in a first single-ended input mode, controls the positive input switch and the negative input switch to be deactivated or to be activated according to the input control signal, the positive input end receives the first sensing voltage outputted from the first decoding unit or receives the second sensing voltage outputted from the second decoding unit, and the negative input end is coupled with a reference voltage.

Compared to the prior arts, the touch sensing apparatus of the present invention utilizes the logic control module to generate the input control signal, so that the input control module controls the positive input switch and the negative input switch to be deactivated or to be activated, and the touch sensing apparatus is switched between the differential input mode and the single-ended input mode according to the input control signal. In general, if the voltage received by the touch sensing apparatus is not the sensing voltage sensed by the boundary sensing pin of the conductive thin film sensor, the input control module executes the differential input mode. If the voltage received by the touch sensing apparatus is the sensing voltage sensed by the boundary sensing pin of the conductive thin film sensor, the input control module executes the single-ended input mode. Hence, the touch sensing apparatus of the present invention utilizes the input control module to control the voltage to be inputted in the differential input mode or the single-ended input mode to increase the sensing voltage accuracy and to have a good ability of resisting noises.

The detailed descriptions and the drawings thereof below provide further understanding about advantages and the spirit of the present invention.

### BRIEF DESCRIPTION OF THE DRAWINGS

FIG. 1 is a schematic view of a touch sensing apparatus for sensing the touch point on a display panel; and

FIG. 2 is a schematic view of an embodiment of the touch sensing apparatus of the present invention.

### DETAILED DESCRIPTION OF THE PREFERRED EMBODIMENT

One embodiment according to the present invention is a touch sensing apparatus. In the present embodiment, the touch sensing apparatus is a mutual capacitance touch sensing apparatus, but not limited thereto.

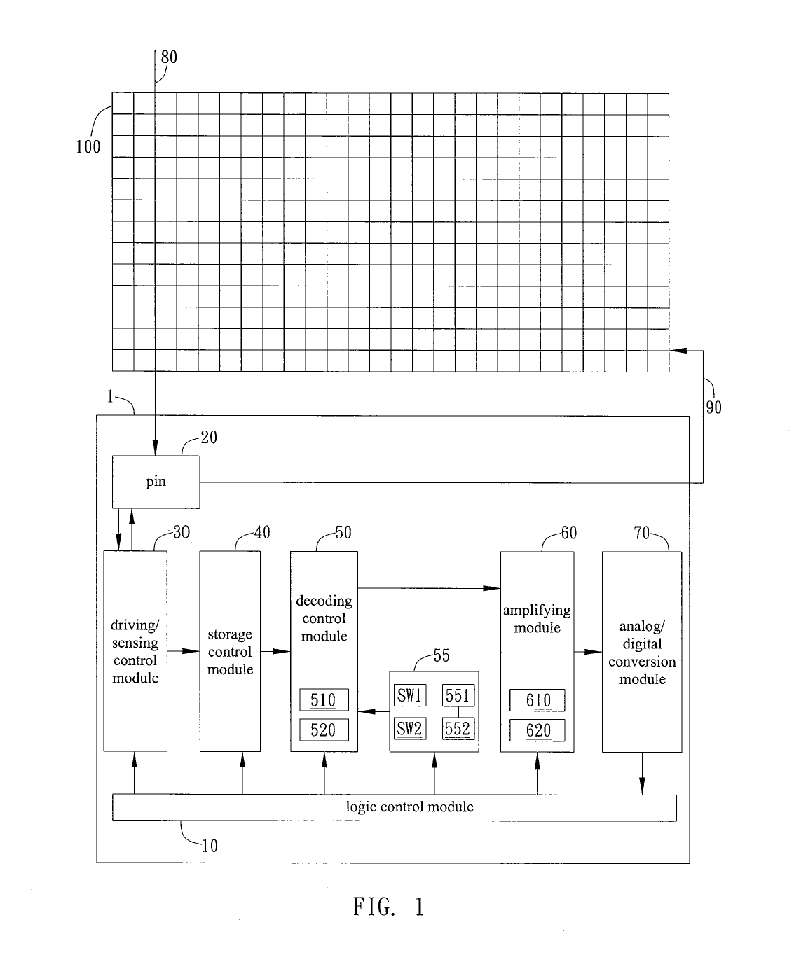

Please refer to FIG. 1; FIG. 1 is a schematic view of a touch sensing apparatus 1 for sensing the touch point on a display panel. As shown in FIG. 1, a liquid crystal display (LCD) panel includes a conductive thin film sensor 100 and the touch sensing apparatus 1. The LCD panel is generally attached to the bottom of the conductive thin film sensor 100, but the location of the LCD panel is not limited to the embodiment. The touch sensing apparatus 1 includes a logic control module 10, a plurality of pins 20, at least one driving/sensing control module 30, at least one storage control module 40, at least one decoding control module 50, at least one input control module 55, at least one amplifying module 60, and an analog/digital conversion module 70.

The at least one driving/sensing control module 30 is coupled with the pins 20 and the logic control module 10. The at least one storage control module 40 is coupled with the driving/sensing control module 30 and the logic control module 10. The at least one decoding control module 50 is coupled with the storage control module 40 and the logic control module 10. The at least one input control module 55 is coupled with the decoding control module 50 and the logic control module 10. The at least one amplifying control module 60 is coupled with the decoding control module 50 and the logic control module 10. The analog/digital conversion module 70 is coupled with the amplifying module 60 and the logic control module 10.

As shown in FIG. 1, the conductive thin film sensor 100 includes a plurality of sensing lines 80 and a plurality of driving lines 90, wherein the driving lines 90 are arranged perpendicular to the sensing lines 80. It is noted that the driving lines 90 and the sensing lines 80 can be interchanged with each other. In other words, the driving lines 90 shown in FIG. 1 can serve as the sensing lines, and the sensing lines 80 shown in FIG. 1 can serve as the driving lines, wherein the arrangement of sensing lines and driving lines can be controlled by the touch sensing apparatus 1.

The pins 20 have more than one function and can switch between different functions based on practical requirements. Examples of the functions include, but are not limited to, driving function, sensing function, ground function, and/or floating function. Each driving/sensing control module 30 controls the pins 20 to execute the sensing function according to a sensing control signal of the control signals and sense a plurality of analog data via a plurality of sensing lines 80 of the conductive thin film sensor 100.

Each driving/sensing control module 30 receives a driving/sensing control signal of the control signals from the logic control module 10 and controls the pins 20 to execute the functions according to the driving/sensing control timing of the driving/sensing control signal, so that the pins 20 respectively sense a first sensing voltage and a second sensing voltage from a first sensing line (not shown) and a second sensing line (not shown) of the conductive thin film sensor 100, wherein the first sensing line and the second sensing line are the sensing lines of adjacent channels.

Each storage control module 40 includes a plurality of storage capacitors (not shown), wherein the storage capacitors at least store, according to a storage control signal of the control signals, the first sensing voltage and the second sensing voltage transmitted from the driving/sensing control module 30.

Each decoding control module 50 includes a first decoding unit 510 and a second decoding unit 520. The first decoding unit 510 and the second decoding unit 520 respectively decode the first sensing voltage and the second sensing voltage outputted from the storage control module 40 according to a decoding control signal of the control signals.

In the present embodiment, the logic control module 10 generates a plurality of control signals having different control timings, wherein the control signals include an input control signal. Each input control module 55 includes a positive input switch SW1 and a negative input switch SW2. The input control module 55 controls, according to the input control signal, the positive input switch SW1 and the negative input switch SW2 to be deactivated or to be activated to control an input mode for the first sensing voltage and the second sensing voltage to be outputted to the amplifying module 60. It is noted that each amplifying module 60 includes a positive input end 610 and a negative input end 620.

When the input control module 55 controls, according to the input control signal, the positive input switch SW1 and the negative input switch SW2 to be deactivated or to be activated, in a first differential input mode, the positive input end 610 receives the first sensing voltage outputted from the first decoding unit 510, and the negative input end 620 receives the second sensing voltage outputted from the second decoding unit 520. On the other hand, in a second differential input mode, the positive input end 610 receives the second sensing voltage outputted from the second decoding unit 520, and the negative input end 620 receives the first sensing voltage outputted from the first decoding unit 510.

In another embodiment of FIG. 1, the input control module 55 further includes an automatic compensating unit 551 and a digital/analog conversion unit 552. The automatic compensating unit 551 is coupled with the logic control module 10 and the decoding control module 50. The digital/analog conversion unit 552 is coupled between the automatic compensating unit 551 and the decoding control module 51. The automatic compensating unit 551 stores the first sensing voltage or the second sensing voltage outputted from the decoding control module 50 and outputs a digital compensation value according to a compensating control signal of the control signals. The digital/analog conversion unit 552 converts the digital compensation value into an analog compensation value to compensate the reference voltage, so that the reference voltage is the same with a voltage sensed by a boundary sensing pin of the conductive thin film sensor 100 or maintains in a constant voltage. When the first sensing voltage or the second sensing voltage outputted from the decoding control module 50 is the boundary sensing voltage of the conductive thin film sensor 100, the logic control module 10 transmits the compensating control signal to the automatic compensating unit 551 to execute a first single-ended input mode or a second single-ended input mode.

When the input control module 55, in the first single-ended input mode, controls the positive input switch SW1 to be deactivated and the negative input switch SW2 to be activated according to the input control signal, the positive input end 610 receives the first sensing voltage outputted from the first decoding unit 510 or the second sensing voltage outputted from the second decoding unit 520, and the negative input end 620 is coupled with the reference voltage.

When the input control module 55, in the second single-ended input mode, controls the positive input switch SW1 to be activated and controls the negative input switch SW2 to be deactivated according to the input control signal, the negative input end 620 receives the first sensing voltage outputted from the first decoding unit 510 or the second sensing voltage outputted from the second decoding unit 520, and the positive input end 620 is coupled with the reference voltage.

The amplifying module 60 determines, according to an amplifying control signal of the control signals, a difference between the first sensing voltage and the second sensing voltage respectively received by the positive input end 610 and the negative input end 620 and amplifies the difference to output an analog data to the logic control module 10.

In practice, the amplifying module 60 can be an arbitrary type of amplifier; the analog/digital conversion module 70 can be an arbitrary type of analog/digital converter; the digital/analog conversion unit 552 can be an arbitrary type of digital/analog converter. However, the amplifying module 60, the analog/digital conversion module 70, and the digital/analog conversion unit 552 are not limited to the embodiment.

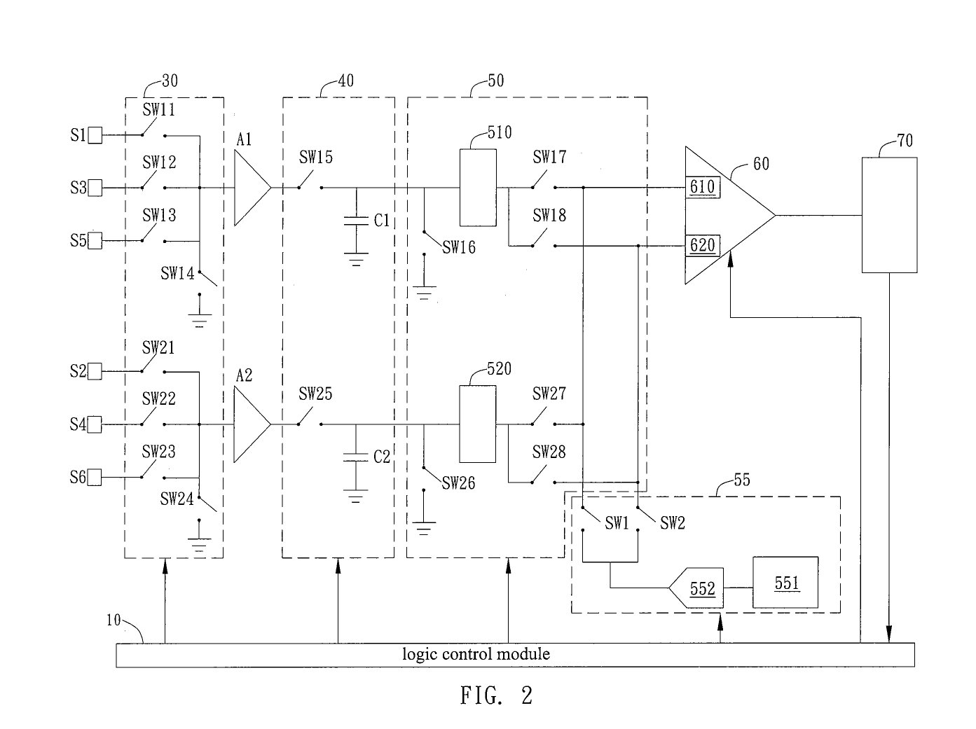

Please refer to FIG. 2. FIG. 2 is a schematic view of an embodiment of the touch sensing apparatus 1 of the present invention.

As shown in FIG. 2, the touch sensing apparatus 1 includes the sensing lines. In the present embodiment, a first pin S1 to a six pin S6 have corresponding sensing lines, wherein the pins are sequentially arranged as the first pin S1, a second pin S2, a third pin S3, a fourth pin S4, a fifth pin S5, and the sixth pin S6. It is noted that the sensing lines corresponding to the first pin S1 and the second pin S2 are sensing lines of adjacent channels.

The driving/sensing control module 30 includes a first sensing switch SW11, a second sensing switch SW21, a third sensing switch SW12, a fourth sensing switch SW22, a fifth sensing switch SW13, and a sixth sensing switch SW23 respectively coupled with the first pin S1 to the sixth pin S6. A buffer A1 is coupled with the first sensing switch SW11 and the storage control module 40. A buffer A2 is coupled with the second sensing switch SW21 and the storage control module 40.

In an exemplarily case, it is assumed that ground switches SW16 and SW26 are in closed state, and the other switches are in open state.

In practical applications, the logic control module 10 generates the driving/sensing control signal outputted to the driving/sensing control module 30 to control the first sensing switch SW11 and the second sensing switch SW21 to be activated (i.e. in closed state), so that the first sensing pin S1 and the second sensing pin S2 respectively receive the first sensing voltage and the second sensing voltage from the first sensing line (not shown) and the second sensing line (not shown) of the conductive thin film sensor 100 and output the first sensing voltage and the second sensing voltage to the buffers A1 and A2, respectively.

The storage control module 40 includes a storage switch SW15, a storage switch SW25, a storage capacitor C1, and a storage capacitor C2. The storage switch SW15 is coupled with the buffer A1 and the storage capacitor C1. The storage switch SW25 is coupled with the buffer A2 and the storage capacitor C2. The logic control module 10 outputs the storage control signal to the storage control module 40 to control the first sensing switch SW11 and the second sensing switch SW21 to be activated (i.e. in closed state) and to control the storage switches SW15 and SW25 to be activated. The storage capacitors C1 and C2 store, according to the storage control signal, the first sensing voltage and the second sensing voltage transmitted from the driving/sensing control module 30.

The decoding control module 50 includes the ground switch SW16, the ground switch SW26, the first decoding unit 510, the second decoding unit 520, a first positive switch SW17, a first negative switch SW18, a second positive switch SW27, and a second negative switch SW28. The first decoding unit 510 is coupled with the storage control module 40 and the first positive switch SW17. The second decoding unit 520 is coupled with the storage control module 40 and the second positive switch SW27. The first negative switch SW18 is coupled with the first decoding unit 510 and the amplifying module 60. The second negative switch SW28 is coupled with the amplifying module 60 and the second decoding unit 520.

As shown in FIG. 2, the logic control module 10 outputs the decoding control signal to the decoding control module 50 to control the storage switches SW15/SW25 and the ground switches SW16/SW26 to be deactivated (i.e. in open state), so that the first sensing voltage and the second sensing voltage are respectively outputted to the first decoding unit 510 and the second decoding unit 520.

As shown in FIG. 2, each amplifying module 60 includes the positive input end 610 and the negative input end 620. It is noted that the positive input switch SW1 and the negative input switch SW2 are in open state in the first differential input mode and the second differential input mode.

In the first differential input mode, the input control module 55 controls the first negative switch SW18 and the second positive switch SW27 to be deactivated and the first positive switch SW17 and the second negative switch SW28 to be activated according to the input control signal. In such a configuration, the positive input end 610 receives the first sensing voltage outputted from the first decoding unit 510, and the negative input end 620 receives the second sensing voltage outputted from the second decoding unit 520.

In the second differential input mode, the input control module 55 controls the first positive switch SW17 and the second negative switch SW28 to be deactivated and the second positive switch SW27 and the first negative switch SW18 to be activated according to the input control signal. In such a configuration, the positive input end 610 receives the second sensing voltage outputted from the second decoding unit 520, and the negative input end 620 receives the first sensing voltage outputted from the first decoding unit 510.

Please refer to FIG. 2. In another embodiment, the input control module 55 further includes the automatic compensating unit 551 and the digital/analog conversion unit 552. The automatic compensating unit 551 is coupled with logic control module 10 and the decoding control module 50. The digital/analog conversion unit 552 is coupled between the automatic compensating unit 551 and the decoding control module 50. The automatic compensating unit 551 records, according to the compensating control signal of the control signals, the digital compensation value corresponding to one of the pins and outputs the digital compensating value according to the compensating control signal. The digital/analog conversion unit 552 converts the digital compensation value into the analog compensation value to compensate the reference voltage, so that the reference voltage is the same with a voltage sensed by the boundary sensing pin of the conductive thin film sensor 100 or maintains in a constant voltage. When the first sensing voltage or the second sensing voltage outputted from the decoding control module 50 is the boundary sensing voltage of the conductive thin film sensor 100, the logic control module 10 transmits the compensating control signal to the automatic compensating unit 551 to execute the first single-ended input mode or the second single-ended input mode.

When the input control module 55, in the first single-ended input mode, controls the first negative switch SW18, the second positive switch SW27, the second negative switch SW28, and the positive input switch SW1 to be deactivated and the first positive switch SW17 and the negative input switch SW2 to be activated according to the input control signal, the positive input end 610 receives the first sensing voltage outputted from the first decoding unit 510, and the negative input end 620 is coupled with the reference voltage. Alternatively, the input control module 55 controls the first positive switch SW17, the first negative switch SW18, the second negative switch SW28, and the positive input switch SW1 to be deactivated and the second positive switch SW27 and the negative input switch SW2 to be activated, so that the positive input end 610 receives the second sensing voltage outputted from the second decoding unit 520, and the negative input end 620 is coupled with the reference voltage.

When the input control module 55, in the second single-ended input mode, controls the first positive switch SW17, the second positive switch SW27, the second negative switch SW28, and the negative input switch SW2 to be deactivated and the first negative switch SW18 and the positive switch SW1 to be activated according to the input control signal, the negative input end 620 receives the first sensing voltage outputted from the first decoding unit 510, and the positive input end 610 is coupled with the reference voltage. Alternatively, the input control module 55 controls the first positive switch SW17, the first negative switch SW18, the second positive switch SW27, and the negative input switch SW2 to be deactivated and the second negative switch SW28 and the positive input switch SW1 to be activated, so that the negative input end 620 receives the second sensing voltage outputted from the second decoding unit 520, and the positive input end 610 is coupled with the reference voltage.

The amplifying unit 60 determines, according to the amplifying control signal of the control signals, the difference between the first sensing voltage and the second sensing voltage respectively received by the positive input end 610 and the negative input end 620 and amplifies the difference to output the analog data to each analog/digital conversion module 70. The analog/digital conversion module 70 is coupled with the amplifying module 60 and the logic control module 10, wherein the analog/digital conversion module 70 converts the amplified analog data into the digital data and outputs the digital data to the logic control module 10.

In practice, the amplifying module 60 can be an arbitrary type of amplifier; the analog/digital conversion module 70 can be an arbitrary type of analog/digital converter; the digital/analog conversion unit 552 can be an arbitrary type of digital/analog converter. However, the amplifying module 60, the analog/digital conversion module 70, and the digital/analog conversion unit 552 are not limited to the embodiment.

The touch sensing apparatus 1 further includes the ground switches SW14, SW24, SW16, and SW26. The ground switch SW14 is coupled with the first sensing switch SW11 and the ground end. The ground switch SW24 is coupled with the second sensing switch SW21 and the ground end. The ground switch SW16 is coupled with the storage capacitor C1 and the ground end. The ground switch SW26 is coupled with the storage capacitor C2 and the ground end. When the first sensing voltage and the second sensing voltage are outputted and respectively stored in the storage capacitors C1 and C2, the logic control module transmits a ground control signal and a storage control signal to the driving/sensing control module 30 and the storage control module 40, respectively, so that the storage switches SW15 and SW25 are deactivated and the ground switches SW14 and SW24 are activated, avoiding the residual charges of the conductive thin film sensor 100 to influence the sensing accuracy of the pins 20. It is noted that before the first sensing voltage and the second sensing voltage are respectively outputted to and stored in the storage capacitors C1 and C2, the logic control module 10 transmits the ground control signal to the decoding control module 50 to control the ground switches SW16/SW26 to be activated, further releasing the voltages stored in the storage capacitors C1/C2 to increase the sensing accuracy during the sensing of the touch sensing apparatus 1.

When the storage switches SW15/SW25 are deactivated and the ground switches SW14/SW24 are activated, the logic control module 10 transmits the decoding control signal to the decoding control module 50 to transmit the first sensing voltage and the second sensing voltage stored in the storage capacitors C1 and C2 respectively to the positive input end 610 and the negative input end 620 of the amplifying unit 60.

Compared to the prior arts, the touch sensing apparatus of the present invention utilizes the logic control module to generate the input control signal, so that the input control module controls respectively the positive input switch and the negative input switch to be deactivated or to be activated, so that the touch sensing apparatus can be switched between the differential input mode and the single-ended input mode according to the input control signal. In general, if the voltage received by the touch sensing apparatus is not the sensing voltage sensed by the boundary sensing pin of the conductive thin film sensor, the input control module executes the differential input mode. If the voltage received by the touch sensing apparatus is the sensing voltage sensed by the boundary sensing pin of the conductive thin film sensor, the input control module executes the single-ended input mode. Hence, the touch sensing apparatus of the present invention utilizes the input control module to control the voltage to be inputted in the differential input mode or the single-ended input mode to increase the sensing voltage accuracy and to have a good ability of resisting noises.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A touch sensing apparatus, comprising:
a logic control module generating a plurality of control signals having different control timings, wherein the control signals comprise an input control signal; and
at least one input control module coupled with the logic control module, wherein each input control module comprises a positive input switch and a negative input switch, the input control module controls, according to the input control signal, the positive input switch and the negative input switch to be deactivated or to be activated to control an input mode of a first sensing voltage and a second sensing voltage; the first sensing voltage and the second sensing voltage are analog data respectively sensed through a first sensing line and a second sensing line of a conductive thin film sensor, and the first sensing line and the second sensing line are sensing lines of adjacent channels.

2. The touch sensing apparatus of claim 1, further comprising:
a plurality of pins;
at least one decoding control module coupled with the logic control module and the at least one input control module, wherein each decoding control module comprises a first decoding unit and a second decoding unit and outputs the first sensing voltage and the second sensing voltage according to a decoding control signal of the control signals; and
at least one amplifying module coupled with the at least one decoding control module and the logic control module, wherein each amplifying module comprises a positive input end and a negative input end, and the amplifying unit determines, according to an amplifying control signal of the control signals, a difference between the first sensing voltage and the second sensing voltage respectively received by the positive input end and the negative input end and amplifies the difference to output an analog data.

3. The touch sensing apparatus of claim 2, wherein when the input control module, in a first differential input mode, controls the positive input switch and the negative input switch to be deactivated or to be activated according to the input control signal, the positive input end receives the first sensing voltage outputted from the first decoding unit, and the negative input end receives the second sensing voltage outputted from the second decoding unit.

4. The touch sensing apparatus of claim 2, wherein when the input control module, in a second differential input mode, controls the positive input switch and the negative input switch to be deactivated or to be activated according to the input control signal, the positive input end receives the second sensing voltage outputted from the second decoding unit, and the negative input end receives the first sensing voltage outputted from the first decoding unit.

5. The touch sensing apparatus of claim 2, wherein when the input control module, in a first single-ended input mode, controls the positive input switch and the negative input switch to be deactivated or to be activated according to the input control signal, the positive input end receives the first sensing voltage outputted from the first decoding unit or the second sensing voltage outputted from the second decoding unit, and the negative input end is coupled with a reference voltage.

6. The touch sensing apparatus of claim 2, wherein when the input control module, in a second single-ended input mode, controls the positive input switch and the negative input switch to be deactivated or to be activated according to the input control signal, the negative input end receives the first sensing voltage outputted from the first decoding unit or the second sensing voltage outputted from the second decoding unit, and the positive input end is coupled with a reference voltage.

7. The touch sensing apparatus of claim 5, wherein each input control module further comprises:
an automatic compensating unit coupled between the logic control module and the decoding control module, wherein the automatic compensating unit records, according to a compensating control signal of the control signals, a digital compensation value corresponding to one of the pins and outputs the digital compensation value according to the compensating control signal; and
a digital/analog conversion unit coupled between the automatic compensating unit and the decoding control module, wherein the digital/analog conversion unit converts the digital compensation value into an analog compensation value to compensate the reference voltage, so that the reference voltage is the same with a voltage sensed by a boundary sensing pin of the conductive thin film sensor or maintains in a constant voltage.

8. The touch sensing apparatus of claim 6, wherein each input control module further comprises:
an automatic compensating unit coupled between the logic control module and the decoding control module, wherein the automatic compensating unit records, according to a compensating control signal of the control signals, a digital compensation value corresponding to one of the pins and outputs the digital compensation value according to the compensating control signal; and
a digital/analog conversion unit coupled between the automatic compensating unit and the decoding control module, wherein the digital/analog conversion unit converts the digital compensation value into an analog compensation value to compensate the reference voltage, so that the reference voltage is the same with a voltage sensed by a boundary sensing pin of the conductive thin film sensor or maintains in a constant voltage.

9. The touch sensing apparatus of claim 7, wherein when the first sensing voltage or the second sensing voltage outputted from the decoding control module is the boundary sensing voltage of the conductive thin film sensor, the logic control module transmits the compensating control signal to the automatic compensating unit to execute the first single-ended input mode or the second single-ended input mode.

10. The touch sensing apparatus of claim 8, wherein when the first sensing voltage or the second sensing voltage outputted from the decoding control module is the boundary sensing voltage of the conductive thin film sensor, the logic control module transmits the compensating control signal to the automatic compensating unit to execute the first single-ended input mode or the second single-ended input mode.

11. The touch sensing apparatus of claim 1, further comprising:
at least one driving/sensing control module coupled with the logic control module and the pins, wherein the driving/sensing control module controls, according to a driving/sensing control signal, the pins to execute a plurality of pin functions, so that the pins respectively sense the first sensing voltage and the second sensing voltage from the first sensing line and the second sensing line of the conductive thin film sensor.

12. The touch sensing apparatus of claim 2, further comprising:
an analog/digital conversion module coupled with the at least one amplifying module and the logic control module, wherein the analog/digital conversion module converts the amplified analog data into a digital data and outputs the digital data to the logic control module; and
at least one storage control module comprising a plurality of storage capacitors and being coupled with the at least one driving/sensing control module and the at least one decoding control module, wherein the storage capacitors at least store the first sensing voltage and the second sensing voltage according to a storage control signal of the control signals.
